(19) United States
(12) Patent Application Publication
(10) Pub. No.: US 2006/0090390 A1
(43) Pub. Date: May 4, 2006

(54) Device for detaching a fish hook from an artificial bait

(76) Inventor: Matthias Barth, Neuwied (DE)

Correspondence Address: Arnold & Ferrera, L.L.P., Suite 630, 2401 Fountain View Drive, Houston, TX, 77057, US

(21) Appl. No.: 11/299,807

(22) Filed: Dec. 12, 2005

Related U.S. Application Data
(63) Continuation of application No. PCT/DE04/01192, filed on Jun. 9, 2004.

(30) Foreign Application Priority Data
Jun. 12, 2003 (DE) 103 27 002.7.23

(51) Int. Cl. A01K 85/00; A01K 97/24

(52) U.S. Cl. 43/43.12; 43/17.2

(57) ABSTRACT

The invention relates to a device for detaching a fish hook from an artificial bait. Said device comprises a first arm, a second arm that is displaceably connected to the first arm and a locking element. One of the two arms can be connected by a first end to the artificial bait or the fishing line and comprises means for receiving a fish hook on a second end. In a first relative arrangement, both arms hold the fish hook in the means for receiving a fish hook so that the latter cannot be detached and in a second relative arrangement release said fish hook. In a first position, the locking element retains both arms in their relative arrangement and in a second position permits a displacement of the arms in relation to one another.

### STATEMENT OF RELATED CASES

This is a continuation of International Application PCT/DE2004/001192, with an international filing date of Jun. 9, 2004, still pending.

### FIELD OF THE INVENTION

The invention refers to a device for removing fish hooks from an artificial bait.

### BACKGROUND

With the angler using artificial baits it happens from time to time that the fish hook will embed itself under water in some obstacle and cannot be released by moving the fishing rod. If one tries to pull strongly on the line to free the hook often the fishing line breaks off, whereby the artificial bait is lost. Since artificial baits are clearly more expensive than fish hooks, a loss of the hook could be accepted, if the artificial bait could be saved.

From DE 41 14 851 C2 a release device is known in which the fish hook is fastened to a short release line, whose free end is held with the pressure a spring between two pressing plates. If the hook gets caught in an obstacle, pressure of the spring is released by pulling on the fishing line and the release line with the fishing hook is thereby released. Thereby, the artificial bait and the release device can be retrieved and used again. With this kind of release device the problem is that one must adapt the traction power to the strength of the fishing line. In addition, a weak spot in the line is produced, which should be avoided in fishing, to prevent the hook tearing off during fighting the fish.

From DE 91 03 953 U1 an artificial bait is known, comprising a bore in which a breaking line is guided. If the hook snags in an underwater obstacle, breaking of the breaking line is caused by pulling on the fishing line and the artificial bait can be retrieved. The problem is that the strength of the breaking line must be adapted to the strength of the fishing line. In addition, there is a danger that the breaking line will tear off during fighting the fish.

From U.S. Pat. No. 6,189,256 B1 an electronically controllable lure is known on which several fish hooks can be fastened. If one of the hooks snags on an obstacle, an electronic signal from the angler throws the hook off and releases the lure again. Such a device is more complex and thus more error-prone than a purely mechanical release device. In addition the costs for such a device are higher, which is problematic, if the not the fish hook but the lure snags on an obstacle and is lost.

### SUMMARY

It is therefore an object of the invention to create a device that allows releasing a fish hook that snags on an obstacle from an artificial bait without the need for external utilities and without the danger of breaking the fishing line, and which is further independent of the fishing line to be used, and does not represent a weak point in the line and is inexpensive to produce.

This object is solved by a device for detaching a fish hook from an artificial bait according to the present invention

A detaching device in accordance with the present invention comprises two arms, which are movably connected to each other. One of the two arms can be connected at a first end with the artificial bait or directly with the fishing line. One of the two arms comprises at a second end means which are suitable for receiving a fish hook. In a first relative arrangement of the two arms, the fish hook is held non-releasably by both arms in the means for receiving a fish hook, while it is released in a second relative arrangement of the two arms and can detach from the means for receiving the hook. A bolting element in a first position holds both arms in the first relative arrangement and in a second position permits movement of the arms with respect to each other.

In the normal use the detaching device is attached to the artificial bait instead of the fish hook, the hook in turn is attached to the detaching device. Thus the first ends of both arms lie above their second ends. The two arms are in the first relative arrangement in order to securely hold the hook, and the bolting element is in the first position, in order to guarantee that both arms remain in the first relative arrangement. The detaching device can be manufactured so that it is more stable than the fishing line and thus does not represent the weakest link of the force chain.

When the hook snags on an obstacle under water, the angler first tries to free the hook by pulling on or moving the fishing rod. If he has no success, he releases the tension on the fishing line, whereby the detaching device and the artificial bait sink on the ground and thus generally lie deeper than the fish hook. Thereby the first ends of both arms move below their second ends and the bolting element moves due to the force of gravity from the first into the second position. At first the two arms are still in the first relative arrangement, but by a short jerk on the fishing line they move from first into the second relative arrangement and thus release the fish hook. By jerking the fishing line the ends of both arms lift over their second ends but, since the jerk is only short, the bolting element has no time to move again into the first position.

In a preferred embodiment, the first arm is an essentially flat element. In a further preferred embodiment, the first arm is a wire bracket. In a further preferred embodiment, the second arm is an essentially flat element. In a further preferred embodiment, the second arm is a wire bracket.

In a further preferred embodiment, one of the essentially flat elements comprises a hole to which the artificial bait or fishing line can be fastened. In a further preferred embodiment, one of the wire brackets comprises an eye to which the artificial bait or the fishing line can be fastened.

In a further preferred embodiment, one of the essentially flat elements comprises at its second end a slot or a differently formed recess, which serves as means for receiving the fish hook. In a further preferred embodiment, one of the wire brackets comprises at its second end a curved section, which serves as means for receiving the fish hook.

The attachment of the two arms together can occur in different places on the two arms. In a preferred embodiment, this attachment takes place between the hole or the eye with which the detaching device can be connected to the artificial bait or the fishing line and the means for receiving the fish hook. In a further preferred embodiment, this attachment takes place under (i.e. toward the second end of the arm) or beside the means for receiving the fish hook.

In a further preferred embodiment, the first and the second arms are two sections of a one-piece wire bracket. These can either be connected to each other at the first end of the two arms, wherein the connection section can then be provided as an eye for the attachment of the artificial bait or the fishing line, or they can be connected to each other at the second end of the two arms, wherein one of the two arms then comprises an eye at its first end for the attachment of the artificial bait or the fishing line.

In a further preferred embodiment, the bolting element is an essentially flat element, which comprises a hole, which is formed so that the bolting element surrounds the two arms when they are in the first relative arrangement and can move along both arms between a first position, in which it surround both arms, and a second position, in which it surrounds only one of the two arms.

In a further preferred embodiment, the bolting device element is an essentially oblong element, which can move along a slot in one of the two arms between a first position, in which it prevents a movement of the two arms with respect to each other, if these are in the first relative arrangement, and a second position, in which it allows a movement of the two arms with respect to each other. In order to guide the bolting element securely along the slot, it can comprise a swelling on both ends.

In a further preferred embodiment, some or all parts of the detaching device are designed in their color, surface finish, etc. such that the detaching device can serve as an artificial bait, whereby the additional acquisition of artificial baits becomes unnecessary.

On the basis of the figures the invention is described below in detail. It is shown in:

### BRIEF DESCRIPTION OF THE DRAWINGS

FIG. 1 is a first preferred embodiment of the invention with the bolting element in the first position, connected to an artificial bait and a fish hook;

FIG. 2 is a further view of the embodiment from FIG. 1 with the bolting element in the second position;

FIG. 3 is a second preferred embodiment of the invention;

FIG. 4 is a third preferred embodiment of the invention;

FIG. 5 is a section through the embodiment from FIG. 4 along the line A-A; and

FIG. 6 is a fourth preferred embodiment of the invention.

### DETAILED DESCRIPTION OF THE DRAWINGS

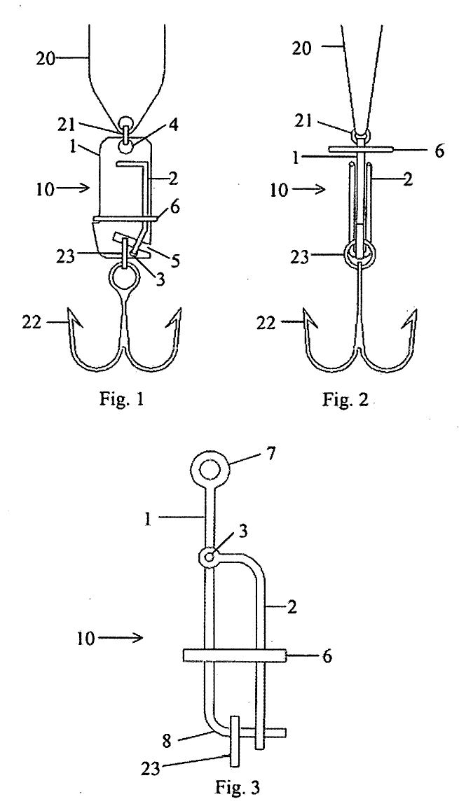

FIG. 1 shows a side view of a first preferred embodiment of the invention. The first arm (1) of the detaching device (10) is a flat element, which comprises a hole (4) at its first end, with which it is connected to an artificial bait (20) via a circlip (21). The means for receiving the fish hook are a recess (5) at the second end of the first arm (1). The second arm (2) is a wire bracket which is connected to the first arm (1) via a hinge (3) and which, in the first relative arrangement of the two arms (1, 2) shown, holds the circlip (23) of a fish hook (22) non-releasably in the recess (5). The bolting element (6) is a disk with a hole, which is adapted to the cross section of the two arms (1, 2), and encloses both arms (1, 2) in their first relative arrangement. Thus, it is ensured that the two arms (1, 2) remain in their first relative arrangement and thus the fish hook (22) remains safely connected to the detaching device (10). Instead of the hinge, a link or another mechanism can be provided by means of which both arms (1, 2) are mounted rotatably with respect to each other.

In FIG. 2 another side view of the detaching device (10) from FIG. 1 can be seen. The bolting element (6) is shown here in the second position, the two arms (1, 2), however, still are in their first relative arrangement. In the preferred embodiment shown here, the second arm (2) extends towards both sides of the first arm (1). It would be however likewise possible that the second arm (2) starting from the hinge (3) extends only towards one side of the first arm (1).

FIG. 3 shows a second preferred embodiment of the invention. The first arm (1) of the detaching device (10) here is a wire bracket at the first end of which an eye (7) for attachment to the artificial bait or the fishing line is located. The means for receiving the fish hook is a curved section (8) at the second end of the first arm (1). In contrast to the preferred embodiment from FIG. 1, the hinge (3), at which the two arms (1, 2) are connected, is not located below, but above the bolting element (6). The bolting element (6) is shown in its first position, in which it holds the two arms (1, 2) in their first relative arrangement.

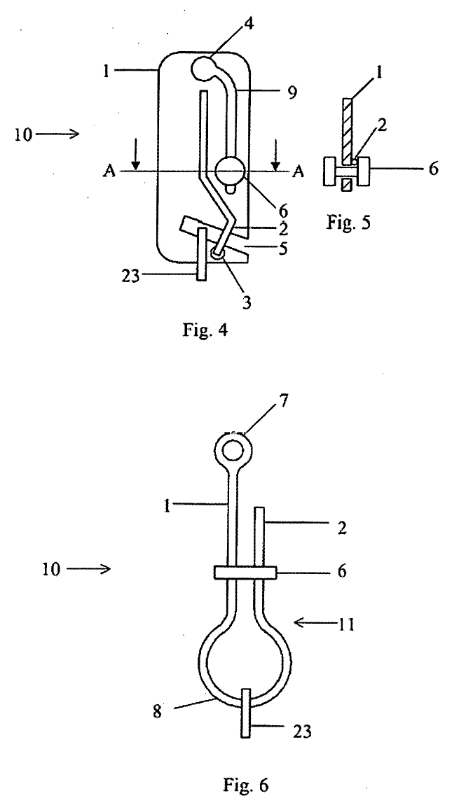

FIG. 4 shows a third preferred embodiment of the invention. In contrast to the preferred embodiment from FIG. 1 the bolting element (6) here is an oblong element, which comprises a swelling at both ends. The bolting element (6) can be inserted through a hole (4) into the slot (9) and can move in said slot along the first arm (1). The bolting element (6) is shown in its first position.

FIG. 5 shows a cut of the preferred embodiment from FIG. 4 along the line A-A, i.e. through the bolting element (6). With the preferred embodiment shown here, the second arm (2) extend only towards one side of the first arm (1).

FIG. 6 shows a fourth preferred embodiment of the invention. Both arms (1, 2) are sections of a one-piece wire bracket (11). At the first end of the first arm (1) an eye (7) is located for attachment to an artificial bait or the fishing line. The means for receiving the fish hook is a curved section (8) at the second end of the first arm (1), which simultaneously represents the connecting section to the second arm (2). The bolting element (6) is a disk with a hole and is shown in its first position, holding the two arms (1, 2) in their first relative arrangement, so that the fish hook remains securely connected to the detaching device (10). The one-piece wire bracket (11) is produced from an elastic material, so that it moves again into the shown shape after release from the fish hook.

1. Device for detaching a fish hook (22) from an artificial bait (20), wherein the device (10) comprises a first arm (1), a second arm (2), which is movably connected to the first arm (1), and a bolting element (6), wherein one of the two arms (1, 2) is connectable to the artificial bait (20) or to the fishing line at a first end, wherein one of the two arms (1, 2) at a second end comprises means (5, 8) for receiving a fish hook, wherein both arms (1, 2) in a first relative arrangement hold the fish hook (22) non-releasably in the means (5, 8) for receiving a fish hook and in a second relative arrangement release the fish hook (22), and wherein the bolting device (6) in a first position holds both arms (1, 2) in the first relative arrangement and in a second position allows movement of the arms (1, 2) with respect to each other.

2. Device according to claim 1, wherein the first arm (1) is a substantially flat element.

3. Device according to claim 1, wherein the first arm (1) is a wire bracket.

4. Device according to claim 1, wherein the second arm (2) is a substantially flat element.

5. Device according to claim 1, wherein the second arm (2) is a wire bracket.

6. Device according to claim 2, wherein the means for receiving a fish hook is a recess (5) in the flat element.

7. Device according to claim 4, wherein the means for receiving a fish hook is a recess (5) in the flat element.

8. Device according to claim 3, wherein the means for receiving a fish hook is a curved section (8) of the wire bracket.

9. Device according to claim 5, wherein the means for receiving a fish hook is a curved section (8) of the wire bracket.

10. Device according to claim 1, wherein the first (1) and the second arm (2) are two sections of a one-piece wire bracket (11).

11. Device according to claim 1, wherein the first (1) and the second arm (2) are connected to each other at their first ends.

12. Device according to claim 1, wherein the first (1) and the second arm (2) are connected to each other at their second ends.

13. Device according to claim 11, wherein the one-piece wire bracket (11) is produced from an elastic material.

14. Device according to claim 1, wherein the bolting element (6) is an essentially flat element comprising a hole and being located movably along the two arms (1, 2) in the first relative arrangement.

15. Device according to claim 2, wherein the bolting element (6) is an essentially oblong element and comprises a swelling at both ends and is located movably along a slot (9) in one of the two arms (1, 2).

16. Device according to claim 4, wherein the bolting element (6) is an essentially oblong element and comprises a swelling at both ends and is located movably along a slot (9) in one of the two arms (1, 2).

17. Device according to claim 1, wherein the movement of the arms (1, 2) with respect to each other is a rotating motion.

18. Device according to claim 1, wherein some or all parts of the device (10) are designed such that the device (10) is usable as an artificial bait.
